(19) United States
(12) Patent Application Publication
(10) Pub. No.: US 2026/0259990 A1
(43) Pub. Date: Sep. 3, 2026

(54) PATCHING SOURCE CODE VULNERABILITIES

(71) Applicant: Microsoft Technology Licensing, LLC, Redmond, WA (US)

(72) Inventors: Ahmed Mahmoud Abdelmottaleb Mohamed BADAWI, Redmond, WA (US); Nicolas Jerome GUIBOURGE, New York City, NY (US)

(73) Assignee: Microsoft Technology Licensing, LLC, Redmond, WA (US)

(21) Appl. No.: 19/066,992

(22) Filed: Feb. 28, 2025

(51) Int. Cl. G06F 21/57

(52) U.S. Cl. CPC G06F 21/577; G06F 21/572

(57) ABSTRACT

In various examples there is a computer-implemented method of generating a patch to fix a vulnerability in a downstream software package. An upstream source code and an upstream patch are received. A downstream software package corresponding to the upstream source code is identified. A training shot is selected from a store of training shots. Input for a generative model is generated, the input comprising the training shot and an inference shot, the inference shot comprising the upstream source code, upstream patch, rejected hunks of the upstream patch and downstream source code. The input is provided to the generative model which generates the downstream patch.

### BACKGROUND

Older versions of a software package, such as software packages that were deployed in the past when the software package was current, often continue to be used despite more recent versions of the software package having been released. The software package may be for an operating system, enterprise software, cloud service, embedded system or other functionality. Patching source code vulnerabilities in the older versions of the software package is not straightforward and may comprise backporting patches. Backporting a patch involves adapting a software fix (also called a patch) from a newer version of a software package to an older one. An older version of a software package may be referred to as a legacy software package.

The embodiments described below are not limited to implementations which solve any or all of the disadvantages of known way of patching source code vulnerabilities.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

The present disclosure relates to automatically generating a patch for a downstream software package as part of a backporting process.

In various examples there is a computer-implemented method of generating a patch to fix a vulnerability in a downstream software package. An upstream source code and an upstream patch are received. A downstream software package corresponding to the upstream source code is identified. A training shot is selected from a store of training shots. Input for a generative model is generated, the input comprising the training shot and an inference shot, the inference shot comprising the upstream source code, upstream patch, rejected hunks of the upstream patch and downstream source code. The input t is provided to the generative model which generates the downstream patch.

In some examples a computer-implemented method comprises validating the generated downstream patch using a validation agent, wherein the validation agent orchestrates applying the patch to the downstream software package, building the patched downstream software package, and testing the patched downstream software package.

In some examples the validation agent also orchestrates regenerating the downstream patch using the generative model when applying the downstream patch to the downstream software package is unsuccessful, building the patched downstream software package is unsuccessful, or testing the patched downstream software fails.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram showing generation of a patch to fix a vulnerability in a downstream software package;

FIG. 2 is a schematic diagram showing a store of pre-computed shots;

FIG. 3 is an example of a prompt provided to a generative model in order to generate a downstream patch;

FIG. 4 is a schematic diagram showing an example method for generating and testing multiple downstream patches in order to select a patch to apply to a downstream package;

FIG. 5 is a schematic diagram of a system for generating a downstream patch including depictions of operational modes of the system;

FIG. 6 is a schematic diagram of showing validating a generated patch, and a feedback loop for re-generating the patch;

FIG. 7 is a flow diagram illustrating a method of generating a patch to fix a vulnerability in a downstream software package; and

FIG. 8 illustrates an exemplary computing-based device in which methods for generating a patch to fix a vulnerability in a downstream software package are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Software packages are often used as part of a system such as an operating system, enterprise software, cloud service or embedded system. A software package is one or more executable computer programs, program documentation and optionally example files demonstrating how components of the software package work. A software package that has been deployed and is being used may have been compiled or built using an older version of source code as compared with the most up to date version of the source code available. Software maintainers of a software package may only maintain a newer, or mainline, version of the software package, also referred to as a current version of the software package. Software maintainers fix vulnerabilities in the mainline version with patches. A patch is a set of changes of source code to be applied when compiling or building a software package to fix a software vulnerability of the software package. In some scenarios, a patch file is a result of a comparison of two versions of source code files. Backporting a patch involves adapting a software fix (also called a patch) from a newer version of a software package to an older one. In other words, backporting involves taking a patch from a version upstream (such as the mainline version) and modifying it to be applicable to a downstream version. The terms “upstream” and “downstream” are relative terms used to describe chronological position of versions of a software package or software patch. A legacy version of a software package is downstream with respect to a mainline version of the software package. A mainline version of a software package is upstream with respect to a legacy version of the software package.

Backporting is important for several reasons including patching bugs without complete system upgrades, ensuring compatibility to prevent disruptions from newer versions, and fulfilling needs for older versions due to regulatory or infrastructural requirements.

Backporting ensures software stability and security without necessitating full system upgrades. However, it presents a pervasive challenge across various systems, including operating systems, enterprise software, cloud services and embedded systems. This is because backporting presents significant difficulties including managing dependencies, resolving conflicts, and ensuring patches do not disrupt existing functionalities. The differences between upstream and downstream software packages can vary widely, from function or signature changes to complex code refactors or the introduction of entirely new logic or files. Mismatches such as these often result in upstream patches failing to apply cleanly to downstream packages.

Manual backporting is time-consuming and labor-intensive. The process requires considerable expertise, time, and effort from developers. For example, when a patch for the latest software version relies on recent changes and features absent in older versions, conflicts arise which demand meticulous resolution. Developers must analyze the differences between upstream and downstream codebases, manually adapt patches, apply them, and then run comprehensive build and test suites to test compatibility and functionality.

A particular use scenario for backporting, which is provided purely as a non-limiting example, is in the context of Azure Linux™. Azure Linux is a Linux distribution which supports cloud infrastructure and edge products. It is desired to maintain the security of packages offered by Azure Linux by promptly fixing vulnerabilities once they are detected. This enhances security for both the platform as its users.

Described herein are methods of automatically generating a patch to fix a vulnerability in a downstream software package. The downstream software package in various scenarios is an older version of an upstream software package. A patch has already been applied to fix the vulnerability in an upstream software package. A downstream patch is computed based on a prompt provided to a generative model. Automatically generating a patch to fix a vulnerability in a downstream software package leads to improved security and reliability by allowing patches to be generated more quickly, more efficiently and more accurately. Methods provided herein are scalable and versatile because they can be applied to adapt patches across various programming languages and software components. Also, the patching process is streamlined using methods described herein leading to more efficient system operations and lower operational costs. Security of a system is improved by ensuring timely and accurate patching of vulnerabilities. Computer implemented functionality given by deployed software is protected from potential exploits and attacks which may arise on account of patches not being applied for known vulnerabilities.

Some of the vulnerabilities are identified using automatic identification of common vulnerabilities and exposures (CVEs). A CVE detection system may scan through source code of many or all of a group of provided packages to identify CVEs. For example, the CVE detection system may run a daily scan.

A patch is a set of changes to source code applied during the compilation or building of a software package. A patch file in various examples refers to a collection of code change descriptions that can be applied to source code. The patch file is typically organized into “diffs” and “hunks.” A “diff” is a section containing a collection of hunks, all related to changes in a single file. In other words, a patch file comprises one or more diffs, with each diff representing the delta or change introduced to a single source file. A diff within a patch file is often identified by a diff header. When a patch requires changes to multiple files in the upstream source code, the patch file contains a separate diff for each source file. Each diff may consist of one or more hunks. A “hunk” is a contiguous block of code within a diff, identified in a patch file by an “@@ header.” To generate a patch for downstream source code from an upstream patch file containing diffs and hunks, individual diffs for the downstream source may be created. Once these diffs are generated, they are aggregated to produce the final patch file for the downstream source code.

A “hunk” as used herein refers to a segment of a patch file detailing changes to be applied to a specific source code file. An upstream patch file may contain several hunks. A “rejected hunk” refers to a portion of an upstream patch that fails to apply to the downstream source code. In essence, a rejected hunk results from attempting to directly apply the upstream patch to the downstream source. By analyzing rejected hunks, problematic portions of the upstream patch can be identified. In some examples, the direct application of the upstream patch to the downstream source serves as a fault-localization mechanism, enabling the identification of specific problematic hunks. Once identified, this information is incorporated into a prompt for a generative model. The generative model uses this prompt to generate the downstream patch. By combining the generative model's training with the detailed instructions and context provided in the prompt, accurate downstream patches can be produced without requiring a large corpus of training data.

In various examples of the present technology there is, a method of generating a patch to fix a vulnerability in a downstream software package comprises receiving upstream source code and an upstream patch. By receiving upstream source code and an upstream patch, known vulnerabilities associated with a software package current version are identified and can be fixed leading to improved security and reliability. A downstream software package corresponding to the upstream source code is identified. Automatically identifying the downstream software package is useful because action can then be taken to fix the vulnerability in the downstream software package while ensuring compatibility to prevent disruptions from newer versions, and fulfilling needs for older versions due to regulatory or infrastructural requirements. As a result there is improved security and reliability. A training shot is selected from a store of training shots. The pre-computed training shots include information about historical patches from developers which are known to have fixed downstream vulnerabilities. The selected training shot may be included in a prompt to a generative model, such as a generative machine learning model so that information from the historical patch can be leveraged to find the desired patch giving improved reliability. Pre-computing training shots saves times and computational resources and allows the shots to be re-used. Input for a generative model which may be a prompt is generated comprising the training shots and an inference shot. The inference shot comprises the upstream source code, upstream patch, rejected hunks of the upstream patch, downstream source code and instructions to compute a downstream patch. The inference shot provides the generative model with information to generate a suitable patch. In this way there is improved security and reliability.

Described hereafter, before describing the accompanying drawings, are various aspects of the technology disclosed herein. Some methods described herein use Chain-of-Thought prompting to generate a downstream patch. Chain-of-Thought prompting is where Chain-of-Thought (CoT) elements are included in the training shot. A Chain-of-Thought training shot comprises a Chain-of-Thought or a series of logical steps capturing the transformation between the upstream patch and its environment and the corresponding successful downstream patch and its environment. A Chain-of-Thought element may comprise a series of operations capturing the transformation between downstream, manually backported patches and their upstream counterparts. The operations mimic reasoning steps that a domain expert, or a rule-based system may go through to backport a patch. Another example of a Chain-of-Thought element comprises operations of information about why rejected hunks were rejected. This provides additional context and steps to transform the upstream patch into the historical downstream patch. In various scenarios the Chain-of-Thought element is computed using a generative model. Chain-of-Thought elements provide the generative model with examples of how complex transformations between inputs and outputs were successfully executed in nuanced environments. Including CoT elements in the prompt is found to result in more accurate downstream patches being generated by the generative model. Furthermore, in some examples where a prompt includes a CoT element, output includes an inference CoT together with a generated downstream patch. This output CoT includes information explaining how the AI model arrived at the downstream patch. The output CoT may be generated using the example CoT element(s) in the training shot included in the prompt.

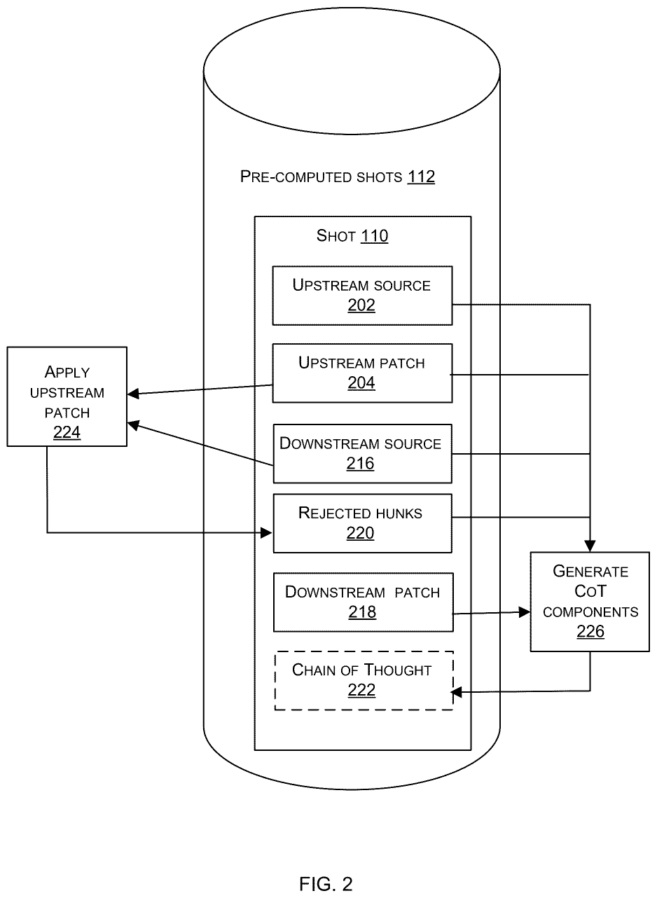

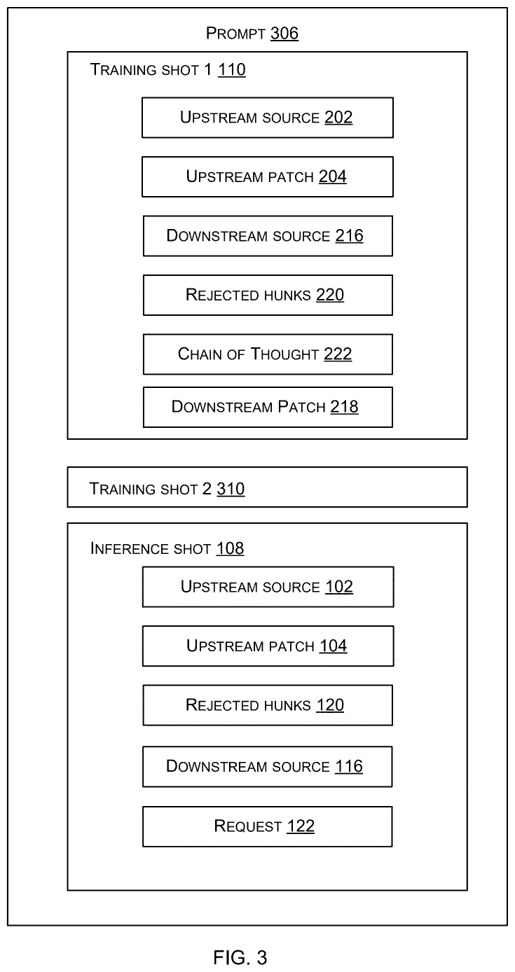

The CoT components 222 in FIGS. 2 and 3 encapsulating logical steps of the patch backporting process may be generated using a generative model. The model be the same model used for generating the patch. In some cases, the model may be fine-tuned for the specific task of generating instructions capturing the transformation and instructions that make up the chain-of-thought. The prompt used to generate the chain-of-thought components comprise inputs sampled from historic patch backports that were previously performed by for example by a human developer or domain knowledge expert In various examples the inputs comprise: An upstream patch, an upstream source file, a downstream source file, the rejected hunks resulting from applying the upstream patch directly to the downstream source file, and a downstream patch. The prompt in various scenarios also contains instructions to the generative model to generate a detailed Chain-of-Thought capturing the essence of the transformations that were made to the upstream patch to produce the backported downstream patch that applied cleanly to the downstream source file. For an example How-to-Fix Chain-of-Thought, the system prompt may be: “You are a helpful assistant tasked with generating a Chain-of-Thought (CoT), or a series of logical steps related to backporting an upstream patch to a downstream source code. You have access to the following information:
The original upstream source file (pre-patch).
The upstream patch.
The downstream source file.
The hunks from the original upstream patch that were rejected by the downstream source.
The downstream patch. Based on this, your task is as follows:
   Explain the transformations necessary to produce the backported downstream patch. Format your response as:
Chain-of-Thought: <Chain-of-thought>”

An example of a prompt for generating a rejection reason CoT is:
“You are a helpful assistant tasked with generating a Chain-of-Thought (CoT), or a series of logical steps to backporting an upstream patch to a downstream source code.
You have access to the following information:
   The original upstream source file (pre-patch).
   The upstream patch.
   The downstream source file.
   The hunks from the original upstream patch that were rejected by the downstream source.
   The downstream patch.
Based on this, your task is as follows:
Explain why the upstream patch failed to apply cleanly and describe how the modifications addressed the rejected hunks.
Format your response as:
Chain-of-Thought:
<Chain-of-thought>”

In various examples, historical data from previously backported patches is collected, aggregated and stored for later use during patch generation. Historic data may be collected from repositories containing upstream patches, upstream source code, downstream patches, and downstream source code. For the historical data, rejected hunks can be determined by attempting to apply upstream patches directly to downstream source code. These rejected hunks are stored as part of the historical dataset. In some scenarios, a structured dataset is prepared (for later use in patch generation) wherein the structured dataset contains: upstream source file, upstream patch, downstream source file, a downstream patch and rejected hunks. The data preparation process can be triggered periodically to incorporate new historical patches, ensuring the dataset remains up-to-date for generating relevant training inputs.

Once historical data has been prepared, methods described herein comprise generating and storing training shots. The training shots may also be serialized. Training shots provide the generative AI model with examples that are tailored to the vulnerability being patched. Generating training shots means that training shots which enhance patch generation efficiency and accuracy can be included in a prompt. Generating pre-computed training shots and storing them avoids on-the-fly shot generation. In various examples training shots are standard shots (containing examples without additional context), How-to-Fix CoT Shots (including explanations for how the backport was achieved), and Reject-Reason CoT Shots (including reasons behind rejected hunks and how they were resolved during backporting). Including CoT elements may mean that the generative model's reasoning ability is improved. In some examples, Chain-of-how Thought components embedded within the shots are useful to guide the generative AI model in reasoning through complex backporting scenarios.

Prompts comprising training shots that contain CoT components are referred to as Chain-of-Thought prompts, whereas those whose training shots do not contain CoT components are referred to as standard prompts. Prompts are examples of input for the generative model. Both standard and CoT prompts can be zero-shot prompts, single-shot prompts, or few-shot prompts. Zero-shot prompts are prompts that do not contain any exemplars. Exemplars may also be called training shots. The terms “exemplar” and “training shot” are used interchangeably herein, while single-shot prompts are those who contain a single exemplar (which can be a standard exemplar or a CoT exemplar). Similarly, few-shot prompts contain more than one exemplar (which can also be either standard exemplars or CoT exemplars).

In various scenarios input is provided to a generative model which is a zero-shot prompt. An advantage of zero-shot prompts is that they are compact. They leverage the model's pre-training or subsequent fine-tuning. They may demonstrate higher effectiveness in generating simpler patches. Although zero-shot prompts do not include explicit training exemplars (shots), their efficiency stems from their concise context body. This brevity may enhance performance in specific scenarios by focusing the model's attention on key instructions, minimizing the potential for distraction or dilution within the generative process. A zero-shot prompt includes an inference shot. The inference shot could comprise: upstream source code, an upstream patch, upstream rejected hunks, downstream source code and instructions to generate a downstream patch. The inference prompt could also include a rejection reason CoT component explaining why the rejected hunks were rejected.

An advantage of single-shot and few-shot prompts is that they leverage explicit training exemplars (shots) in addition to the model's pre-training or fine-tuning. These exemplars provide additional, environment-specific training tailored to the ecosystem where the backport process occurs. This is because the training examples are derived from historically successful backporting processes within the same environment. Further, the exemplars (shots) in these prompting techniques may be “standard shots,” relying on the model's pre-training or fine-tuning to deduce the mapping or transformation between the inputs and outputs of each training example. Alternatively, the exemplars may include Chain-of-Thought (CoT) components that provide additional directives or cues. These components guide the model in learning the transformations between inputs and outputs more explicitly, enabling it to generalize this learning to unseen patches. This approach may yield higher efficacy in scenarios where the patch is complex or non-trivial.

A training shot in various scenarios comprises: upstream patch, upstream source file, downstream patch (manually backported), downstream source file, rejected hunks, and optionally a chain of thought element. Pre-computing shots speeds up the patch generation process by retrieving pre-computed shots. Also, during patch generation shot selection is enabled based on language, difficulty, or relevance to the specific vulnerability being patched. Sometimes, an inference shot which is also part of the prompt includes a request for generating a chain of thought such as a How-to-Fix or a Reject-Reason for the generated downstream patch. In an example where the training shot includes a How-to-Fix element, an inference shot includes a request for a How-to-Fix. In an example where the training shot includes a Reject-Reason element, an inference shot includes a request for a Reject-Reason.

During patch generation, patches in some examples are generated using a few-shot prompting techniques enabled by the pre-computed training shots. In an example, appropriate training shots are retrieved based on the context of the vulnerability. Depending on the type of training shot used in the prompt, the generative model may generate a patch using Standard, How-to-Fix CoT, or Reject-Reason CoT prompting.

Some methods described herein further comprise validating the generated patch in order to check whether the generated patch meets functional and structural requirements before deployment. Validation may include applying the patch, building the patched package and performing automated post-build tests. Sometimes, if any validation operation fails, failure details are logged and used to re-generate a patch in a feedback loop. Using an iterative feedback loop means that in some examples continuous refinement of the generated patch is enabled. In a scenario, if validation fails a validation agent triggers a regeneration mechanism. Failure details are incorporated into a refined input prompt, which includes the failed validation step, error logs, and relevant metadata from the previous iteration. A new patch is generated by the generative model and revalidated. The feedback loop continues until the patch successfully passes validation or a predefined iteration limit is reached. This agentic feedback loop accommodates application and environment specific requirements, allowing the validation operations to vary in scope and complexity.

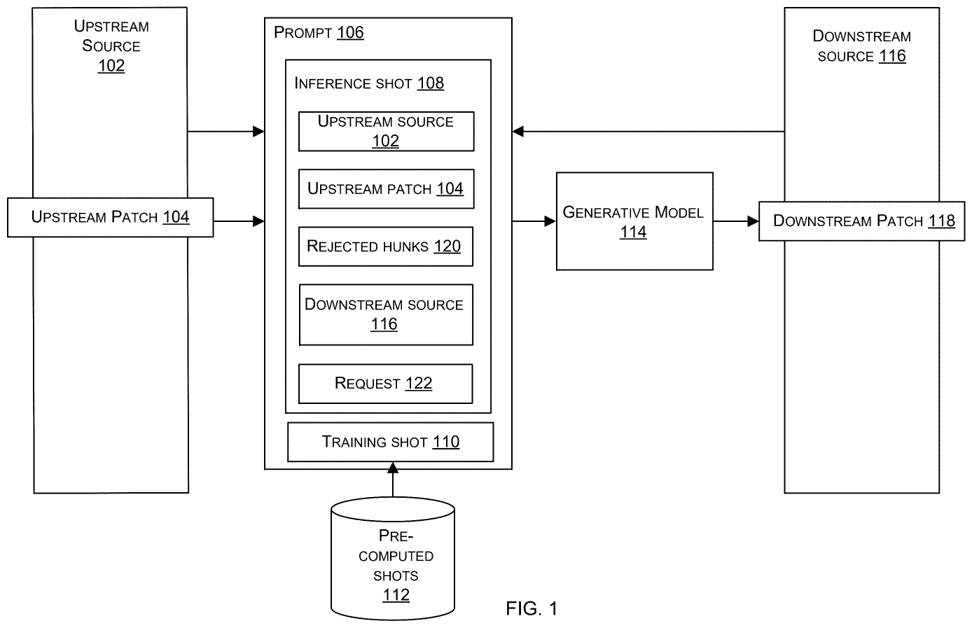

Referring to the accompanying drawings, FIG. 1 is a schematic diagram showing generation of a patch to fix a vulnerability in a downstream software package. Upstream source code 102 has an upstream patch 104 applied to it. Upstream source code, or upstream source, 102 is part or all of the mainline version of a software package i.e. the most recent version of the software package which is actively updated by its developers to patch emerging vulnerabilities. Upstream patch 104 is a patch which in some examples is made by the software package maintainers to the mainline version to fix a vulnerability in the upstream source 102. Upstream source 102 is upstream source code before the patch is applied. Downstream source 116 is an older, still utilized version of the package which may be called a legacy version of the package. Downstream source 116 is not maintained by package developers whereas upstream source 102 is maintained by package developers. Downstream patch 118 is generated from the upstream patch 104 using backporting to apply the downstream patch 118 to an older version of the package 116. Downstream patch 118 is generated using generative model 114.

Generative model 114 may be a generative machine learning model such as GPT-4, GPT-40, BLOOM, LLAMA, GEMINI, CLAUDE or other similar models like MISTRAL, FALCON, PALM, or T5. The generative model 114 may be a large language model or may be a smaller generative model such as from the Microsoft PHI model series. The generative model 114 may have a transformer architecture using attention such as self-attention or cross-attention. Sometimes, the generative model is fine-tuned using a training dataset comprising training pairs, each training pair comprising a historical upstream patch and a corresponding historical downstream patch, each patch comprising a set of changes of source code. The set of changes in source code may be in the form of text. Generative model 114 is provided with input which in some examples is a prompt 106. In further examples the input may be an application programming interface API input. The prompt 106 in FIG. 1 comprises an inference shot 108 and a training shot 110. An inference shot provides the generative model with information to generate a suitable patch. In various examples, the inference shot includes upstream source code, upstream patch, rejected hunks of the upstream patch, downstream source code and instructions to compute a downstream patch. A training shot, or exemplar, provides the generative model with examples of patch generation. In other examples the prompt is a zero-shot prompt which does not include a training shot. Referring back to FIG. 1, the inference shot 108 comprises upstream source code 102, the upstream patch 104, downstream source code 116 and instructions (shown as request 122 in FIG. 1) to compute a downstream patch 118. Inference shot 108 further comprises rejected hunks 120, which are sections of the upstream patch which fail to apply to the downstream source. Training shot 110 is selected from a store of pre-computed training shots 112. The training shot includes information about previous backporting processes which have resulted in a successful downstream patch. More information regarding prompts for generative model 114 are described with respect to FIG. 2 and FIG. 3 below.

FIG. 2 is a schematic diagram showing a store of pre-computed shots 112. The store is a database, memory or other store. The store is depicted in FIG. 2 as a single entity although in some examples it is distributed. The store 112 stores backported patch information, including downstream patches written by developers, and, for each downstream patch, the upstream source, upstream patch and downstream source which the developer used when writing the patch, and optionally a Chain-of-Thought (CoT) component, depending on the prompt technique in use. A Chain-of-Thought training shot is a training shot which includes one or more CoT components. A Chain-of-Thought training shot comprises a chain of thought or a series of logical steps capturing the transformation between the upstream patch and its environment and the corresponding successful downstream patch and its environment.

The store of pre-computed shots includes training shots such as training shot 110. Training shot 110 includes details of a previous backporting process comprising upstream source 202, upstream patch 204, downstream source 216 and downstream patch 218.

Also included in the training shot are rejected hunks 220. Rejected hunks are automatically generated at 224 using upstream patch 204 and downstream source 216 by applying the upstream patch to the downstream source. Rejected hunks 220 are sections of upstream patch 204 that fail to apply to the downstream source 216. This is often because of mismatches in the code context or surrounding lines. Rejected hunks 220 indicate a discrepancy between the intended and actual modifications. Rejected hunks 220 are generated at 224 by applying the upstream patch to the downstream source. Including the Chain-of-Thought (CoT) components rejected hunks 220 in training shot 110 which in turn is included in a prompt input to the generative model improves the prompt because it includes information about how the historical downstream patch was determined and why it is applicable.

The training shot further optionally comprises a Chain-of-Thought components 222 as mentioned above. Chain-of-Thought components such as 222 may be generated (automatically by the shot generator) for each downstream patch 218 as described in more detail below. The Chain-of-Thought components encapsulate the logical processes navigated during a backporting task. Including chain-of-Thought components 222 in a training shot such as 110, which is in turn included in a prompt, means that the prompt is improved. This is because Chain-of-Thought elements provide more information about the transformation between the upstream patch and its original environment and the backported patch and its downstream context. As depicted in FIG. 2, Chain-of-Thought components 222 are generated at 226 using the downstream patch 218, downstream source 216, upstream patch 204 and upstream source 202, and rejected hunks 220. In various scenarios Chain-of-Thought components are generated using a generative model, which may be the same generative model 114 used to generate the downstream patch as described with reference to FIG. 1. Generation of Chain-of-Thought elements including “Rejection reason” and “How-to-Fix” components is described in more detail below. In various examples the generative model is a large language model (LLM) such as GPT-4 or any of the other generative models mentioned above.

Examples of Chain-of-Thought (CoT) components 222 include components which may be called “Rejection reason” components and components which may be called “How-to-Fix” components. Rejection reason CoT components provide a reasoning chain that explains why the upstream patch fails when applied directly to the downstream source. This reasoning offers more context and results in more accurate grounding of the resulting downstream patch. A Rejection reason CoT component may be generated with a generative model by providing as model input a known upstream patch 204, upstream source 202, downstream source 216, downstream patch 218, rejected hunks 220 and a prompt such as “provide a rejection reason for why the upstream patch could not be directly applied to the downstream source”.

How-to-Fix CoT components include intermediate steps between an upstream patch and a downstream patch. For example, intermediate steps explain how the rejected hunks are transformed into a downstream patch. For example, the intermediate steps include identifying individual changes to the rejected and providing an explanation of why the change fixes a problem. The use of intermediate steps improves the generative model's capability to generate solutions to reason about the logical steps taken to transform the upstream patch into its downstream counterpart. The How-to-Fix CoT component outlines the adaptation process of the patch from the upstream to its new downstream environment and serves as a detailed guide. The operation of the How-to-Fix CoT component improves the patch generating process because it guides the generative model towards a more accurate patch. A How-to-Fix CoT component may be generated with a generative model by providing as model input a known upstream patch 204, upstream source 202, downstream source 216, downstream patch 218, rejected hunks 220, and a prompt such as “provide steps outlining the adaptation process from upstream patch to downstream patch”. CoT components in various examples are generated and embedded into training shots. The training shots can be retrieved later and included in a prompt for patch generation.

Depicted in FIG. 2 is an example training shot 110 contained within a store of pre-computed shots 112. In various scenarios the store 112 includes many shots such as 110 and shot 110 is merely an example shot from the store 112. Shot 110 in FIG. 2 is shown comprising various elements and components which are non-limiting and it is to be understood that shots can additionally or alternatively include other elements, components and information.

In order to generate input for the generative model, one or more training shots are selected from the store of pre-computed shots to be included in a prompt 106 which is input to a generative model 114. In various examples, the training shots (also called exemplars) may be selected from store 112 using a rules-based process. Additionally or alternatively, exemplars are selected from the store 112 based on metadata associated with the exemplars. Example metadata includes programming language, software package data and complexity data such as length of the patch or number of source code modifications included in the patch. The exemplars may be random package exemplars which are randomly selected from various packages, offering a broad range of contexts and scenarios to the model and enhancing its general adaptability. The exemplars may be same package exemplars drawn specifically from the same package providing focused insights into package-specific patterns and practices. For example, exemplars are chosen by first identifying exemplars from the same package as the target patch based on exemplar metadata. This may involve matching labels of the exemplar identifying the package. From exemplars which relate to the same package as the target patch, exemplars may be selected using random sampling. The exemplars may be increasing complexity exemplars which are chosen based on their complexity. The complexity starts from simpler to more complex and this means that the model is gradually challenged to understand and adapt to increasingly sophisticated scenarios. In some examples, exemplars have an associated complexity score. The complexity score may be based on length of the historical upstream patch, for example, or number of source code modifications. The exemplars may be language-specific exemplars which are selected from codebases written in the same programming language as the target patch. This means that the model is primed with relevant syntactic and stylistic nuances of the programming language. Exemplars may have an associated language label. From exemplars which have the same programming language as the language of the target patch (as may be determined from exemplar metadata), exemplars may be chosen using random sampling.

FIG. 3 is an example of input provided to a generative model in order to generate a downstream patch. The example input in FIG. 3 is example prompt 306, which is an example of prompt 106 in FIG. 1. Prompt 306 comprises a first training shot 110 and a second training shot 310. The training shots have been selected from a store of pre-computed shots 112 for example in the ways described above with reference to FIG. 2. Training shot 110 is shown in FIG. 1 and FIG. 2 and in this example shot 110 comprises upstream source 202, upstream patch 204, downstream source 216, rejected hunks 220, Chain-of-Thought 222 and downstream patch 218 from a first historical backporting process. Although not shown, second training shot 210 may comprise corresponding elements from a second historical backporting process. Also included in prompt 306 is inference shot 108, which includes upstream source 102, upstream patch 104, rejected hunks 120, downstream source 116, and request 122 for a downstream patch for the downstream source corresponding to the present backporting process. When a prompt such as prompt 306 is provided to generative model 114, the generative model is response generates a downstream patch and optionally a Chain-of-Thought (CoT) component.

In various scenarios, upstream and downstream source code included in input such as prompts including 106, 306 in a training shot or an inference shot may be some or all of a source code file. In some examples, the source code corresponds to: a singular function, a contiguous block of code, multiple functions, multiple contiguous segments, a source code file, multiple source code files. Sometimes, pertinent sections of source code are extracted using a fault-localization process. For example, a fault-localization process takes as input the upstream source and patch, the downstream source and rejected hunks in order to extract portions of downstream source and upstream source to be included in the inference prompt. In another example, the fault-localization process extracts portions of historical upstream and downstream source to be included in a training shot. The fault-localization process may use a generative model such as an LLM to extract pertinent code sections or may use rules to extract pertinent code sections.

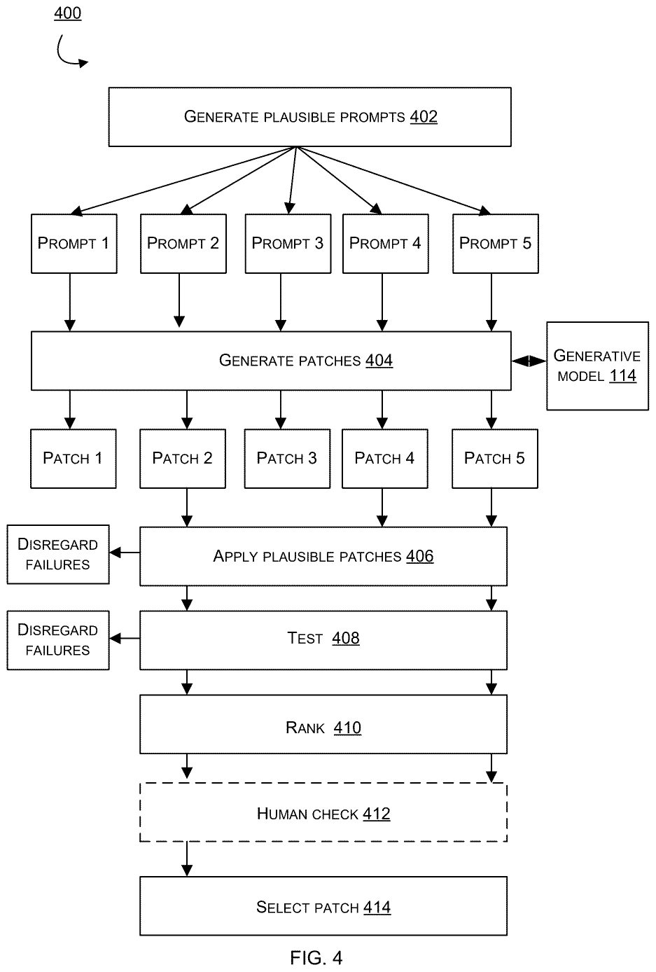

In various scenarios as described herein, a downstream patch is generated based on input for the generative model such as prompt 106, 306 using a generative model. Input is provided to the generative model and in response the generative model returns a downstream patch. Sometimes, multiple prompts are used to generate multiple candidate patches, from which a patch is selected. An example is shown in FIG. 4 described below. Based on methods such as method 400, preferred input types may be selected. In various scenarios, input comprising a single prompt is used including: at least one training shot comprising historical upstream source, upstream patch, upstream rejected hunks, downstream source, a Chain-of-Thought (CoT) component, and a downstream patch; and inference shot comprising upstream source, upstream patch, upstream rejected hunks, downstream source, a request to generate a downstream patch and a request to generate How-to-Fix Chain-of-Thought explaining how to transform rejected hunks into the downstream patch.

FIG. 4 is a schematic diagram showing an example method 400 for generating and testing multiple downstream patches in order to select a patch to apply to a downstream package. The method of FIG. 4 is computer implemented and may be performed by a patch generator such as patch generator 510 described later in this document. At block 402, multiple plausible prompts are generated. In the example shown in FIG. 4, five prompts are generated. Each of the five prompts are different. For example one of the prompts may be prompt 306 from FIG. 3 which includes two training shots and an inference shot. The shots sometimes are generated using a generative model such as an LLM or using rules. Prompts may be described as zero-shot prompts or few-shot prompts. Zero-shot prompts do not include any examples (training shots) alongside the task. Few-shot prompts include one or more examples accompanying the task offering context to aid the model in determining an expected format or other feature of the output. Standard prompts are direct requests for immediate answers without requiring the model to provide output representing reasoning. Chain-of-Thought prompts ask the model to produce output which outlines intermediate steps before reaching a conclusion. In various scenarios such as the scenario of FIG. 4, the following five shots are generated.

Prompt 1 (zero-shot, standard prompt) does not include any training shots and includes an inference shot comprising upstream source, upstream patch, upstream rejected hunks, downstream source and a request to generate a downstream patch.

Prompt 2 (zero-shot, rejection reason Chain-of-Thought prompt) does not include any training shots and includes an inference shot comprising upstream source, upstream patch, upstream rejected hunks, downstream source, a rejection reason Chain-of-Thought component (as described above) explaining why the rejected hunks were rejected, and a request to generate a downstream patch.

Prompt 3 (few-shot, standard prompt) includes at least one training shot comprising historical upstream source, upstream patch, upstream rejected hunks, downstream source, and downstream patch. Prompt 3 includes an inference shot comprising upstream source, upstream patch, upstream rejected hunks, downstream source and a request to generate a downstream patch.

Prompt 4 (few-shot, how-to-fix Chain-of-Thought prompt) includes at least one training shot comprising historical upstream source, upstream patch, upstream rejected hunks, downstream source, a How-to-Fix chain-of-thought component explaining how the rejected hunks were transformed into applicable code, and a downstream patch. Prompt 4 includes an inference shot comprising upstream source, upstream patch, upstream rejected hunks, downstream source, a request to generate a downstream patch and a request to generate How-to-Fix chain-of-thought explaining how to transform rejected hunks into the downstream patch.

Prompt 5 (few-shot, rejection reason Chain-of-Thought prompt) includes at least one training shot comprising historical upstream source, upstream patch, upstream rejected hunks, downstream source, a rejection-reason chain-of-thought component explaining the rejection reason, and a downstream patch. Prompt 5 includes an inference shot comprising upstream source, upstream patch, upstream rejected hunks, downstream source, a request to generate a downstream patch and a request to generate rejection-reason chain-of-thought.

At block 404, each prompt is sent to a generative model 114 to generate a patch. The five example prompts described above produce one patch each. At block 406 each patch is applied to the downstream source code and the patch generator assesses the results. At this stage, patches which are not cleanly applied to the downstream source code are discarded by the patch generator. In the example shown, patches 2, 4, and 5 apply cleanly but patches 1 and 3 do not and this means that patches 1 and 3 are disregarded. Later, a re-generation mechanism is presented to refine the failed patches in a self-enhancing feedback loop.

At block 408 the candidate patches are tested automatically by the patch generator. Testing including at block 408 in some examples comprises applying the generated patch file to downstream code, compiling/building the downstream package using the generated patch, and running tests created for the upstream source. For each patch, a patched package is built and tested. Packages dependent on the backported package are also built and tested by applying test cases from the package. If all of these tests are passed then the patches are ranked, as shown at block 410.

In some examples, candidate patches are ranked based on entropy. In examples, the patches are ranked based on mean entropy and sum entropy. For each downstream patch, a plurality of tokens are received from the generative model. Each token has an associated probability. Mean entropy is the average of the probabilities and sum entropy is the sum of the entropies. Mean entropy and sum entropy may be calculated according to:

$$mean entropy = {\sum }_{i = 1}^{n} ( \frac{1}{n} ) log ( {p}_{{t}_{i}} )$$

$$sum entropy = {\sum }_{i = 1}^{n} log ( {p}_{{t}_{i}} )$$

where i represents a token and p is a probability of the token such that mean entropy of a patch is the sum over tokens of the patch of the probability of each token, divided by the number of tokens. A patch is a piece of code which is a sequence of characters and the sequence of characters is formed from a plurality of tokens generated by the generative model. The generative model computes a probability pₜ_{ᵢ} for each of the tokens it generates.

It is recognized herein that patches with lower entropy represent more suitable patches as a lower entropy reflects a higher adherence to conventional coding patterns which suggests improved patch quality and maintainability. It is found that using entropy to rank patches results in good performance and improves security and robustness.

Patches may also be ranked based on cost and speed. For example, patches with a lower associated computational cost may be ranked higher. Patches with a faster associated speed may be ranked higher.

In some examples, a human developer reviews the top candidate patches as shown at 412 then at 414 a patch is selected for merging with the downstream package. In examples with a human-in-the-loop approach the patch may be selected by the human developer. Top candidate patches can be selected automatically based on selecting the highest ranking candidate patch based on any one or more of: entropy, cost and speed. In some examples, a differencing user interface may be provided to aid the human developer in investigating, examining, and signing off on the generated patch. This interface can present various successful patches generated by the system, allowing the developer to compare alternatives, analyze their applicability, and select the most suitable patch.

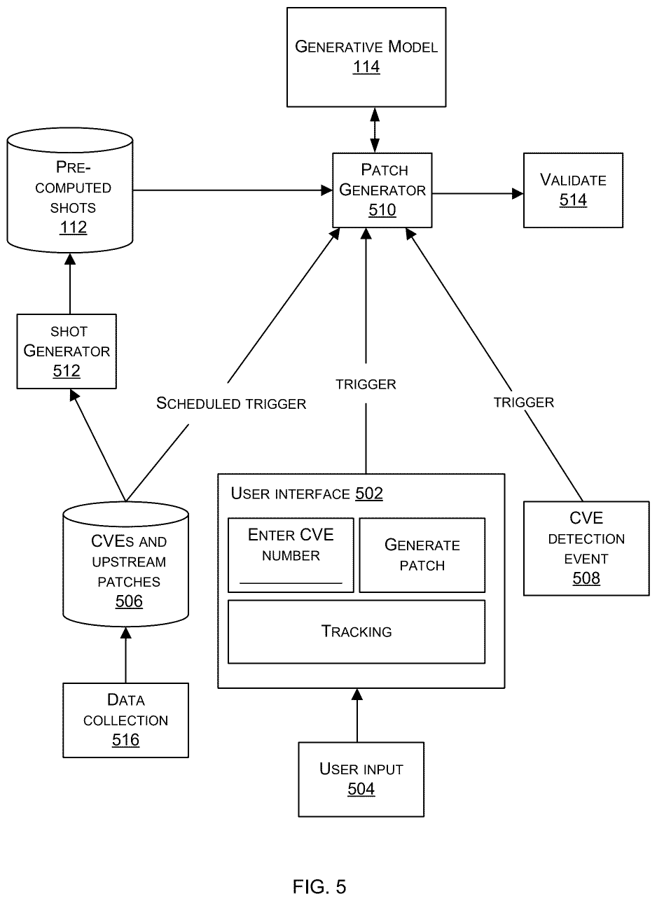

FIG. 5 is a schematic diagram of a patch generator 510 for generating a downstream patch. FIG. 5 includes depictions of operational modes of the patch generator 510 and also shows a shot generator 512 and other apparatus used with the patch generator. The patch generator 510 and the shot generator 512 are both computer implemented. The patch generator 510 and/or the shot generator 512 are deployed as a cloud service in some examples.

Shown in FIG. 5 is a store of shots 112 which are used to generate a patch at 510. The shots 112 may be pre-computed. The store may be a database, memory or other store populated with pre-computed shots as described with reference to FIG. 2. In various examples, data collection and preparation 516 periodically obtains new CVEs (Common Vulnerabilities and Exposures) and stores this data in data store 506. Additionally or alternatively, a link to an upstream patch provided by NIST or another source is used to obtain a historical upstream patch. The link in some examples refers to a specific commit ID or pull request against an upstream source repository such as GitHub (trademark). Using commit ID, a patch file corresponding to the upstream patch may be retrieved from the upstream source repository. Source code files corresponding to a software package just before the change was applied may also be retrieved from a repository such as GitHub using an earlier commit ID. Data collection and preparation 516 may be triggered at a cadence to fetch newly detected vulnerabilities and prepares and formats the input which is later consumed by patch generator 510. In some examples shot generation 512 is also triggered at a cadence, wherein shot generation 512 follows data collection 516. Patch generator 510 may have different triggers.

The patch generator 510 generates patches using a generative model 114 as explained further with reference for example to FIG. 1 above. FIG. 5 depicts some example operational modes of the patch generator 510 for generating a downstream patch. Using a CVE identifier, the patch generator 510 is able to query a database of upstream patches to find an upstream patch associated with the CVE identifier. Patch generation is triggered to consume the data stored in data store 506. The triggering is sometimes scheduled to occur automatically daily or weekly or at other intervals. Additionally or alternatively, the patch generator 510 has a user interface 502 to receive user input 504 and trigger patch generation. Shown in FIG. 5 is a portion of user interface for entering a CVE number and a button called “Generate Patch” which the user may click on or otherwise select to trigger downstream patch generation. In further examples the user may interact with the user interface in another suitable way to trigger patch generation. In various scenarios, user interface 502 also displays tracking data so that the user may track the patch generation process, for example the user interface may display any generated patches and/or results of tests such as whether the patch applied cleanly or whether the patch has been validated 514. Another way in which patch generation can be triggered is based on an event-based trigger. A CVE detection event shown at 508 indicates that a new vulnerability has been detected, and the detection triggers the patch generator 510 to generate a patch. Once a patch has been generated by the patch generator the patch is stored or automatically applied to the downstream software package.

FIG. 5 shows patch validation 514. In some scenarios the patch is only automatically applied to the downstream software package if it is validated successfully. Validation 514 in various examples comprises applying the patch to a copy of the downstream software package. Some of the methods and systems described herein include validation using an agentic, self-enhancing feedback loop, which also re-generates patches upon failure of any validation operation.

Described hereafter is an example of validation using an agentic, self-enhancing feedback loop. The agentic, self-enhancing feedback loop bridges generative and deterministic components of automated patch management. The generative component produces patches using a generative model while the deterministic component ensures their functional and structural integrity through a series of validation operations. By iterating between these components, the system autonomously refines patches, reducing manual intervention and increasing reliability.

Sometimes, a patch produced by a generative model is a plausible patch but does not successfully pass all validation operations on the first attempt. Multiple iterations with feedback may be performed to ground the patch in the specific context of downstream dependencies and ecosystem-specific validation requirements. Conversely, deterministic validation operations, such as applying patches, building the package, and testing functionality, provide structured rigor but do not adaptively improve patches.

Iterative feedback, where failures in validation prompt patch regeneration using a generative AI model, results in improved downstream patches. The patch validation process 514 in various scenarios includes the following operations. The process begins with applying a plausible patch to a copy of the downstream software package. This involves verifying that the lines of code surrounding the changes in the patch file align with corresponding lines in the target source file. If the patch is successfully applied, the system proceeds to subsequent validation operations. Failures, such as mismatched contexts or invalid formats, trigger a regeneration process. Failures may be reported with detailed logs, including mismatched lines and error messages. These are incorporated into the generative model's re-generation prompt to produce a new patch. After applying the patch, the system can perform a build to ensure successful compilation and integration into the existing software. Once the build completes, automated post-build tests validate the functionality of the patched package. Example tests include checking for regressions and ensuring compatibility with dependencies.

Any failures during build or testing trigger the regeneration process, where failure information, which may be detailed failure information, such as compilation errors or test logs, is passed to the generative model for improved patch generation.

A re-generation prompt includes details about the failure and enables the generative model to refine its output. In some examples a re-generation prompt includes one or more the following elements: Failure Context including whether the failure occurred during patch application, build, or testing; Error logs including specific details about the failure, such as mismatched context lines, compilation errors, or failed test cases; Validation Status including a summary of the current validation iteration, including which steps passed or failed; and Patch Metadata including information about the previous patch, including its intended modifications and scope. For example, a prompt might include:
“Patch application failed due to mismatched context at lines 42-46. The rejected hunks are shown below. Please regenerate the patch with corrected context to address the rejected hunks and ensure alignment with downstream dependencies.” This detailed input enables the generative model to adaptively improve its output, ensuring the next patch iteration is more likely to succeed.

The example validation process iterates through patch application, build, and testing until the patch is successfully validated or a predefined iteration limit (e.g., three attempts) is reached. Each iteration may be tracked by a unique identifier, with results logged in both short-term (e.g., Redis) and long-term (e.g., Azure SQL) storage.

Failures trigger a controlled regeneration process. A validation agent ensures that all steps are executed sequentially and monitors for failures. A generative model creates a refined patch based on detailed failure prompts. An iteration manager tracks iteration counts and ensures that the process terminates upon reaching the maximum limit.

An agentic feedback loop is modular such that validation operations—patch application, build, testing—are independent and configurable, allowing the system to adapt to application-specific requirements in terms of scope, complexity, and number of steps. The feedback loop means that validation is improved because the feedback loop is capable of handling diverse software environments and patch validation criteria. Therefore, the validation is more efficient and straightforward to implement. Improved validation means that a downstream patch is generated more efficiently and effectively, leading to improved source code. Iterative improvement may be used such that each iteration leverages the outcomes of previous steps to refine the generative model's output.

The described example validation system may accommodate varying validation workflows based on application requirements. Steps may include additional components, such as security audits or performance benchmarks, regression tests, integration tests, end-to-end tests which are managed by the validation agent in the same sequential and autonomous manner. By supporting dynamic step configurations, the framework enables tailored validation workflows that address specific use cases, enhancing its versatility across different software systems.

In various examples, worker agents are used to execute each validation step. A patch application worker may apply the patch and verify its integration. A build worker may compile the patched package, ensuring it integrates with the codebase. A test worker may execute post-build tests, validating functionality and identifying regressions. These worker agents operate under the coordination of the validation agent, which ensures sequential execution and manages failures autonomously.

Upon successful completion of all validation operations, the process is marked as complete, with results stored for long-term analysis. If the iteration limit is reached without success, the process concludes as failed. This structured termination ensures efficient use of resources while providing clear outcomes for every validation attempt.

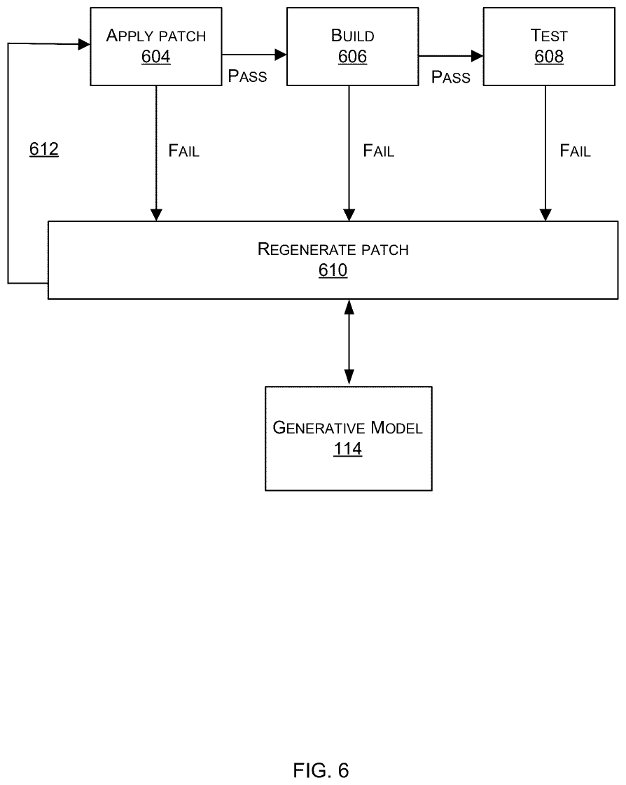

Some of the methods and systems described herein include validation such as the validation depicted in FIG. 6. Shown in FIG. 6 are validation operations including applying a plausible patch 604, running a build 606, and performing post-build tests 608. Applying a patch 604 comprises including the patch into a copy of the downstream software package. An example patch application process includes matching a context (such as lines of code surrounding the changes) in a patch file to a target source code file. If the context lines match correctly, the patch will be applied. It is noted that patch application in this example is not related to whether code changes introduced by the patch are syntactically valid or logically sound. Once the patch is applied successfully, the downstream package is built and tested. A patch application failure will result in patch regeneration 610 which comprises generating a new patch using generative model 114.

At 606, a copy of the downstream package with the patch applied is built. Post-build tests 608 are then performed on the build. Tests are performed on the build, and further tests may be performed on packages dependent on the backported package.

If the build fails then a new patch is generated at 610. If the patch is applied and built successfully but one or more tests fails then a new patch is generated. The new patch is generated using generative model 114. A re-generation prompt is input into the generative model which outputs the new patch. In various example, the prompt includes the patch and failure information which may include but is not limited to: whether patch application failed or passed, whether building failed or passed, whether the one or more tests failed or passed, error messages from any of the validation operations, the plausible patch, rejected hunks, upstream source code and patch, downstream source code. In various examples, the prompt is a zero-shot or few-shot prompt.

An example of a re-generation prompt includes a system message, objectives, available resources and a format request. For example, the system message is “You are a highly skilled assistant tasked with improving an AI-generated patch that failed to apply to the downstream source code”. Example objectives provided to the generative model include: “Examine the error messages and rejected hunks to identify why the patch could not be applied. Understand discrepancies between the upstream and downstream codebases”; “Provide a detailed explanation of the changes made, including the rationale for each modification, and highlight key differences between the upstream and downstream contexts”. Available resources are provided for example failed AI-generated patch, rejected hunks and error logs, upstream source code and patch, and downstream source code. An example format request is “Format your response as follows: Explanation: <Step-by-step analysis of failure and rationale for the new patch.> Downstream Patch: <Provide the refined downstream patch here.>”.

The new patch, once generated using a generative model and a prompt as described above, is then validated as represented by arrow 612 in FIG. 6. In various examples, the validation is iterative. If validation is unsuccessful because applying the patch fails, building fails or one or more tests fails then a new patch is generated either until validation is successful or a maximum number of iterations is reached. In some examples, the maximum number of iterations is three.

In various examples, a validation agent (not shown in FIG. 6) ensures that each validation step 604, 606, 608 is executed sequentially (first applying, then building, then testing) and that any failure prompts a patch regeneration process. The validation agent can comprise functionality to prompt a generative model, a memory module, a planning module and tools.

A planning module is responsible for coordinating the sequence of tasks required in the validation process. This is achieved through asynchronous event-based triggers and regeneration logic. Validation operations are dynamically initiated based on system events or scheduled tasks. A downstream patch is iteratively improved by analyzing failure logs and re-invoking the generative model 114 with tailored prompts.

A memory module serves as the backbone for storing and accessing data required throughout the validation and regeneration cycles. Short-term memory is utilized for caching intermediate results and validation logs (e.g., Redis cache). Long-term memory is used for persistent storage of patch metadata and validation outcomes (e.g., SQL database). A message queue or service bus facilitates communication between distributed worker agents. Each validation step (e.g., patch application, build, testing) corresponds to specific topics, publishers and subscribers that handle task execution and response logging.

Tools may encompass individual, modular components responsible for executing specific validation tasks for example applying a patch, building the downstream package, and running post-build tests. Applying a patch comprises incorporating the proposed patch into the downstream source code and validates context alignment. Building a package comprises compiling the patched software to verify syntax and integration. Running post-build tests ensures functional correctness and regression prevention through automated test suits.

In various examples, the validation agent orchestrates the validation process and ensures that each validation step is executed sequentially. For example, before sending instructions to build a patched package, the orchestrator checks that the patch has been applied successfully such as by checking for a completion message from an Apply Patch Worker agent. An apply patch worker agent is an agent configured to apply a patch to a software application such as in operation 604. The orchestrator may then instruct a Build Worker agent to build the package. A build worker agent is an agent configured to carry out build process 606. Before sending instructions to run tests, the orchestrator checks that the build is successful for example by listening for a completion message from the Build Worker agent. The orchestrator may then send instructions to a Tests Worker agent which is an agent configured to carry out operation 608. If any of the validation operations fail (so that the orchestrator finds that completion is not successful from the Apply Patch, Build and Tests Worker agents) the orchestrator checks whether the maximum number of iterations has been reached. If the maximum number of iterations has not been reached, the orchestrator instructs a Re-generation Worker agent to regenerate the patch. The Re-generation Worker agent regenerates the patch using a generative model and a prompt in some scenarios. Using agents allows for autonomous, iterative execution of validation tasks. It is to be understood that other examples include performing the three validation operations without a validation agent.

In some scenarios, validating a patch using methods shown schematically in FIG. 6 may be applied to a patch produced by a human developer or to a patch produced by a generative model. In various examples, a patch produced by the human is enhanced using a process of self-enhancing validation as in FIG. 6 to regenerate the patch 610 and produce an improved patch. The improved patch may be included in a training shot such as 110 or 310 in a prompt for automatically generating subsequent patches. This improves the quality of the subsequently generated patch because an improved patch was included in the training shot.

In various examples described herein is a system for validating patches. The system comprises a validation agent configured to sequentially execute validation operations including: applying the patch to a downstream software package, building the patched package, and performing post-build tests. The system also comprises a feedback loop for iterative patch regeneration upon validation failure, the feedback loop including a generative model to produce refined patches and failure data (e.g., error logs, patch metadata) as input to the generative model. A termination mechanism halts the feedback loop upon successful validation, or reaching a predefined iteration limit.

Sometimes, an input prompt for regenerating a patch includes details of the failed validation step, error logs and metadata about the previous patch.

In various examples a feedback loop terminates upon successful completion of all validation operations; or reaching a predefined iteration limit. The iteration limit may be configurable based on patch complexity or the application domain.

Sometimes, validation operations are dynamically configurable to include additional steps, such as security audits or performance benchmarks.

Various scenarios include a validation agent wherein the memory module stores a history of validation outcomes, and/or failure-specific logs including context, mismatches, build errors, and failed test cases.

Examples of post-build tests include regression testing and/or dependency validation for compatibility with dependent software packages.

In various use cases the planning module ensures success of each validation step before proceeding and autonomous execution of validation operations by worker agents.

Validated patches may be stored as references to improve future generative model outputs.

Alternatively, or in addition, the functionality of the patch generator such as generator 510 described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

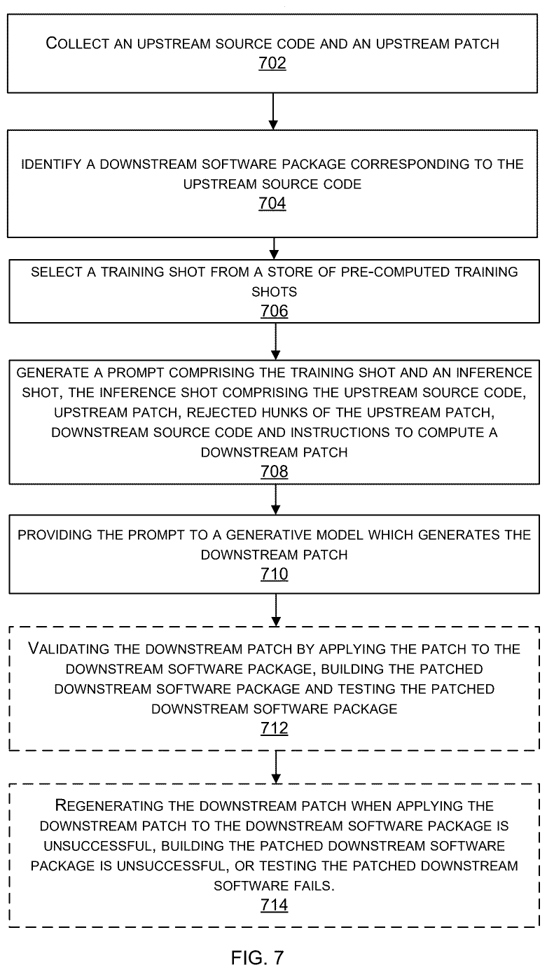

FIG. 7 is a flow diagram of a method of generating a patch to fix a vulnerability in a downstream software package. The method of FIG. 7 is computer implemented and may be performed by a patch generator 510 such as that of FIG. 5. The vulnerability is a security vulnerability, for example. At block 702 an upstream source code such as upstream source 102 and upstream patch such as upstream patch 104 are received. Upstream source code corresponds to a more recent version of the software package before a patch is applied. Upstream source code and upstream patches may be stored in data store 506 described with reference to FIG. 5.

At block 704, a downstream software package (which may also be called a legacy version) corresponding to the upstream source code is identified. At block 706 a training shot such as shot 110 is selected from a store of training shots such as store 112. The store of pre-computed training shots is described in more detail above with reference to FIG. 2. In various examples the training shot is selected based on being from the same package as the downstream package, based on complexity, or based on programming languages as described in more detail above. In some examples, the training shot is selected at random. In some examples, multiple training shots are selected and the multiple shots increase in complexity. Using a training shot is found to improve quality of generated patches.

At block 708 input for the generated model is generated. The input comprises the training shot and an inference shot. The inference shot comprises the upstream source code, upstream patch, rejected hunks of the upstream patch, downstream source code and instructions to compute a downstream patch. In some examples such as in FIG. 3, the input comprises more than one training shot. In other examples the input comprises Chain-of-Thought elements in the inference shot and/or the training shot. In some other examples where the input is a zero-shot prompt, no training shots are included. At block 710, using a patch generator, the input is provided to a generative model such as model 114 which generates the downstream patch to fix the vulnerability in the downstream version of the package. The generative model returns, in response to the input, the downstream patch. The downstream patch is stored and applied automatically to the downstream software package.

At block 712, the generated downstream patch may be validated. Validation as shown at block 712 includes applying (such as applying 604) the patch to the downstream software package, building (such as applying 606) the patched downstream software package and testing the patched downstream software package (for example testing 608). In a scenario the validation shown at block 712 is an example of validation 514 described with reference to FIG. 5 above. At block 714, the downstream patch is regenerated. The downstream patch is regenerated when applying the downstream patch to the downstream software package is unsuccessful, building the patched downstream software package is unsuccessful, or testing the patched downstream software fails. In various examples the downstream patch is regenerated using a generative model. In some scenarios the regeneration at block 714 is an example of patch regeneration 610 described above with reference to FIG. 6.

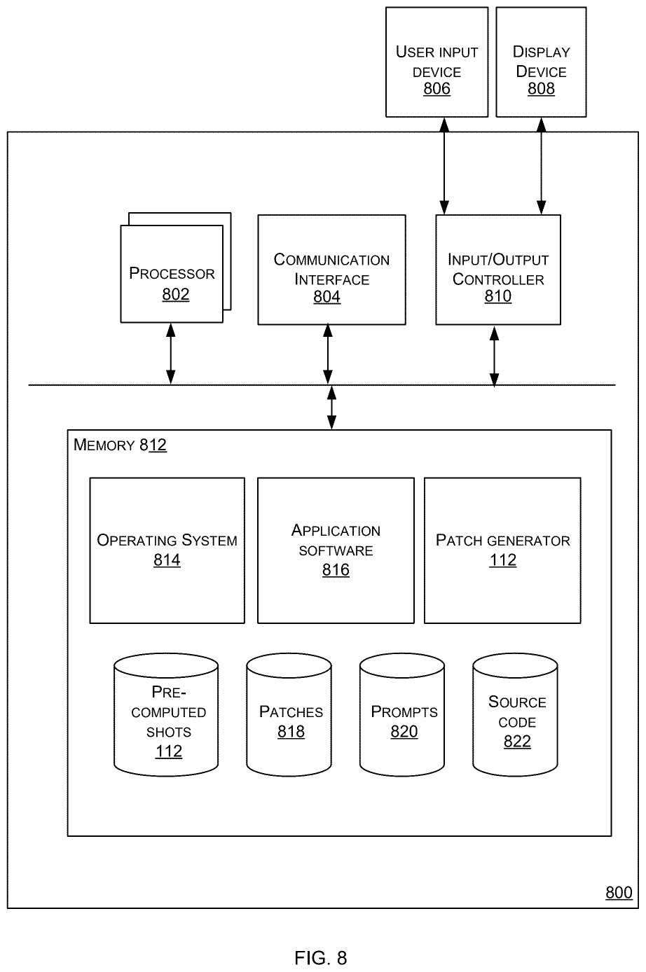

FIG. 8 illustrates various components of an exemplary computing-based device 800 which is implemented as any form of a computing and/or electronic device, and in which methods for downstream patch generation are implemented in some examples. In some examples, the computing-based device 800 is a general-purpose computer that is activated or reconfigured by a computer program stored in the computer. In other examples the computing-based device is specially constructed for the intended purpose. In an example where the patch generator is deployed as a cloud service the computing-based device 800 may be a web server or a compute node of a data centre.

Computing-based device 800 comprises one or more processors 802 which are microprocessors, controllers or any other suitable type of processors for processing computer executable instructions to control the operation of the device in order to generate a patch to fix a vulnerability in a downstream software package. The processors 802 may include at least one general-purpose processing device such as a central processing unit, microprocessor, complex instruction set computing (CISC) microprocessor, reduced instruction set computing (RISC) microprocessor, or other general-purpose processing device. In some examples, for example where a system on a chip architecture is used, the processors 802 include one or more special-purpose processing device such as a fixed function block (also referred to as an accelerator) which implements a part of the method of generating a patch to fix a vulnerability in a downstream software package in hardware (rather than software or firmware). The special-purpose processing device may be configured to execute instructions for performing the operations and methods described herein. Platform software comprising an operating system 814 or any other suitable platform software is provided at the computing-based device to enable application software 816 to be executed on the device. In various examples the application software 816 is stored in memory 812. In some scenarios, also stored in memory 812 is a patch generator 112, a store of pre-computed shots 112, patches 818 comprising upstream and/or downstream patches, prompts 820 and source code 822. The computing-based device 800 has access to a generative model via communications interface 804.

The computer executable instructions are provided using any computer-readable media that is accessible by computing based device 800. Computer-readable media includes, for example, computer storage media such as memory 812 and communications media. Computer storage media, such as memory 812, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, optical storage, magnetic storage, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 812) is shown within the computing-based device 800 it will be appreciated that the storage is, in some examples, distributed or located remotely and accessed via a network or other communication link (e.g. using communication interface 804).

The computing-based device 800 also comprises an input/output controller 810 arranged to output display information to a display device 808 which may be separate from or integral to the computing-based device 800. The display information may provide a graphical user interface such as graphical user interface 502. The input/output controller 810 is also arranged to receive and process input from one or more devices, such as a user input device 806 (e.g. a mouse, keyboard, camera, microphone or other sensor). In some examples the user input device 806 detects voice input, user gestures or other user actions and provides a natural user interface (NUI). This user input may be used to generate a patch to fix a vulnerability in a downstream software package for example if the user input is a CVE number. In an embodiment the display device 808 also acts as the user input device 806 if it is a touch sensitive display device. The input/output controller 810 outputs data to devices other than the display device in some examples, e.g. a locally connected printing device (not shown in FIG. 8).

Any of the input/output controller 810, display device 808 and the user input device 806 may comprise NUI technology which enables a user to interact with the computing-based device in a natural manner, free from artificial constraints imposed by input devices such as mice, keyboards, remote controls and the like. Examples of NUI technology that are provided in some examples include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that are used in some examples include intention and goal understanding systems, motion gesture detection systems using depth cameras (such as stereoscopic camera systems, infrared camera systems, red green blue (rgb) camera systems and combinations of these), motion gesture detection using accelerometers/gyroscopes, facial recognition, three dimensional (3D) displays, head, eye and gaze tracking, immersive augmented reality and virtual reality systems and technologies for sensing brain activity using electric field sensing electrodes (electro encephalogram (EEG) and related methods).

Methods for generating a patch to fix a vulnerability in a downstream software package of the disclosure operate in an unconventional manner to achieve improved security, accuracy, scalability, and efficiency of the disclosure.

Alternatively or in addition to the other examples described herein, examples include any combination of the following:

Clause A. A computer-implemented method of generating a patch to fix a vulnerability in a downstream software package, the method comprising:
receiving an upstream source code and an upstream patch;
identifying a downstream software source code corresponding to the upstream source code;
selecting a training shot from a store of pre-computed training shots;
generating input for a generative model, the input comprising the training shot and an inference shot, the inference shot comprising the upstream source code, upstream patch, rejected hunks of the upstream patch and downstream source code; and providing the input to the generative model which generates the downstream patch.

Clause B. The method of clause A wherein rejected hunks of the upstream patch are produced by applying the upstream patch directly to the downstream source code.

Clause C. The method of clause A or clause B wherein the training shot comprises historical upstream source code, a historical upstream patch, historical downstream source code and a historical downstream patch.

Clause D. The method of clause C wherein the training shot further comprises a Chain-of-Thought element comprising steps for transforming the historical upstream patch into the historical downstream patch, the Chain-of-Thought element generated by the generative model or a second generative model.

Clause E. The method of clause C or clause D wherein the training shot further comprises a Chain-of-Thought element including text detailing why the historical rejected hunks were rejected, the Chain-of-Thought element generated by the generative model or a second generative model.

Clause F. The method of any preceding clause wherein the inference shot comprises any of the following: instructions for generating a Chain-of-Thought element explaining how to transform rejected hunks into a downstream patch; instructions for generating a rejection reason Chain-of-Thought.

Clause G. The method of any preceding clause wherein the generative model has been fine tuned using a training dataset comprising historical upstream patches and historical downstream patches.

Clause H. The method of any preceding clause further comprising applying the downstream patch to the downstream software package.

Clause I. The method of any preceding clause wherein providing the input to the generative model is triggered by one or more of: a user-provided input at a user interface, a common vulnerabilities and exposures “CVE” detection event, a scheduled trigger.

Clause J. The method of any preceding clause wherein the input is a first prompt of a plurality of prompts, each prompt being used to generate a downstream patch to generate a plurality of candidate downstream patches, wherein the method further comprises:
applying each candidate patch from the plurality of candidate downstream patches to the downstream source and disregarding any patch which produces an error.
testing the remaining candidate patches and disregarding any patch which fails a test;
ranking the remaining candidate patches based on one of more of entropy, cost and speed; and
selecting a patch based on the ranking.

Clause K. The method of any preceding clause comprising: generating a plurality of downstream patches from the generative model; receiving, from the generative model for each downstream patch, a plurality of tokens, each token having an associated probability; computing an entropy of each patch as an average of the probabilities; and ranking the downstream patches according to an entropy of each of the patches.

Clause L. The method of any preceding clause wherein selecting a training shot comprises selecting a training shot based on metadata associated with the training shot or selecting a training shot based on random selection.

Clause M. The method of any preceding clause wherein the inference shot further comprises instructions to compute a downstream patch.

Clause N. The method of any preceding clause further comprising validating the generated downstream patch using a validation agent, wherein the validation agent orchestrates:
applying the patch to the downstream software package;
building the patched downstream software package; and
testing the patched downstream software package.

Clause O. The method of clause N wherein the validation agent further orchestrates: regenerating the downstream patch using the generative model when applying the downstream patch to the downstream software package is unsuccessful, building the patched downstream software package is unsuccessful, or testing the patched downstream software fails.

Clause P. The method of clause O wherein regenerating the downstream patch using the generative model comprises providing a re-generation prompt to the generative model, the re-generation prompt comprising one or more of: details of unsuccessfully applying the downstream patch, building the software package or testing the patched downstream software, an error log, metadata about the downstream patch, a Chain-of-Thought component.

Clause Q. The method of clause O or clause P wherein the validation agent comprises:
a planning module for sequential execution of validation operations;
a memory module for storing validation results and failure logs;
a regeneration module for generating a re-generated patch based on failure data; and
a feedback loop,
wherein according to the feedback loop a patch is iteratively regenerated until a downstream patch is applied successfully, built successfully and the patched downstream software package passes all tests or until a maximum number of iterations is reached.

Clause R. A computer system for validating and iteratively regenerating an automatically generated patch to fix a vulnerability in a downstream software package, the system comprising:
a validation agent for executing validation operations comprising applying the patch to the downstream software package, building the patched package and performing post-build tests;
a feedback loop for iterative patch regeneration upon validation failure, the feedback loop including a generative model to produce re-generated patches and failure data for use as input to the generative model via a prompt; and
a termination mechanism which halts the feedback loop upon successful validation or reaching a predefined iteration limit.

Clause S. An apparatus comprising:
a processor;
a memory storing instructions that, when executed by the processor, perform a method comprising:
receiving an upstream source code and an upstream patch;
identifying a downstream software package corresponding to the upstream source code;
selecting a training shot from a store of training shots;
generating input for a generative model, the input comprising the training shot and an inference shot, the inference shot comprising the upstream source code, upstream patch, rejected hunks of the upstream patch and downstream source code; providing the input to the generative model which generates the downstream patch.

Clause T. A computer storage medium having computer-executable instructions that, when executed by a computing system, direct the computing system to perform operations comprising:
receiving an upstream source code and an upstream patch;
identifying a downstream software package corresponding to the upstream source code;
selecting a training shot from a store of training shots;
generating input for a generative model, the input comprising the training shot and an inference shot, the inference shot comprising the upstream source code, upstream patch, rejected hunks of the upstream patch and downstream source code;
providing the input to the generative model which generates the downstream patch; and
applying the downstream patch to the downstream software package.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A computer-implemented method of generating a patch to fix a vulnerability in a downstream software package, the method comprising:
receiving an upstream source code and an upstream patch;
identifying a downstream software source code corresponding to the upstream source code;
selecting a training shot from a store of training shots;
generating input for a generative model, the input comprising the training shot and an inference shot, the inference shot comprising the upstream source code, upstream patch, rejected hunks of the upstream patch and downstream source code; and
providing the input to the generative model to generates the downstream patch.

2. The method of claim 1 wherein rejected hunks of the upstream patch are produced by applying the upstream patch directly to the downstream source code.

3. The method of claim 1 wherein the training shot comprises historical upstream source code, a historical upstream patch, historical downstream source code and a historical downstream patch.

4. The method of claim 3 wherein the training shot further comprises a Chain-of-Thought element comprising steps for transforming the historical upstream patch into the historical downstream patch, the Chain-of-Thought element generated by the generative model or a second generative model.

5. The method of claim 3 wherein the training shot further comprises a Chain-of-Thought element including text detailing why the historical rejected hunks were rejected, the Chain-of-Thought element generated by the generative model or a second generative model.

6. The method of claim 1 wherein the inference shot comprises any of the following:
instructions for generating a Chain-of-Thought element explaining how to transform rejected hunks into a downstream patch;
instructions for generating a rejection reason Chain-of-Thought.

7. The method of claim 1 wherein the generative model has been fine tuned using a training dataset comprising historical upstream patches and historical downstream patches.

8. The method of claim 1 further comprising applying the downstream patch to the downstream software package.

9. The method of claim 1 wherein providing the input to the generative model is triggered by one or more of: a user-provided input at a user interface, a common vulnerabilities and exposures “CVE” detection event, a scheduled trigger.

10. The method of claim 1 wherein the input is a first prompt of a plurality of prompts, each prompt being used to generate a downstream patch to generate a plurality of candidate downstream patches, wherein the method further comprises:
applying each candidate patch from the plurality of candidate downstream patches to the downstream source and disregarding any patch which produces an error.
testing the remaining candidate patches and disregarding any patch which fails a test;
ranking the remaining candidate patches based on one of more of entropy, cost and speed; and
selecting a patch based on the ranking.

11. The method of claim 1 comprising: generating a plurality of downstream patches from the generative model; receiving, from the generative model for each downstream patch, a plurality of tokens, each token having an associated probability; computing an entropy of each patch as an average of the probabilities; and ranking the downstream patches according the an entropy of each of the patches.

12. The method of claim 1 wherein selecting a training shot comprises selecting a training shot based on metadata associated with the training shot or selecting a training shot based on random selection.

13. The method of claim 1, wherein the inference shot further comprises instructions to compute a downstream patch.

14. The method of claim 1 further comprising validating the generated downstream patch using a validation agent, wherein the validation agent orchestrates:
applying the patch to the downstream software package;
building the patched downstream software package; and
testing the patched downstream software package.

15. The method of claim 14 wherein the validation agent further orchestrates: regenerating the downstream patch using the generative model when applying the downstream patch to the downstream software package is unsuccessful, building the patched downstream software package is unsuccessful, or testing the patched downstream software fails.

16. The method of claim 15 wherein regenerating the downstream patch using the generative model comprises providing a re-generation prompt to the generative model, the re-generation prompt comprising one or more of: details of unsuccessfully applying the downstream patch, building the software package or testing the patched downstream software, an error log, metadata about the downstream patch, a Chain-of-Thought component.

17. The method of claim 15 wherein the validation agent comprises:
a planning module for sequential execution of validation operations;
a memory module for storing validation results and failure logs;
a regeneration module for generating a re-generated patch based on failure data; and
a feedback loop,
wherein according to the feedback loop a patch is iteratively regenerated until a downstream patch is applied successfully, built successfully and the patched downstream software package passes all tests or until a maximum number of iterations is reached.

18. A computer system for validating and iteratively regenerating an automatically generated patch to fix a vulnerability in a downstream software package, the system comprising:
a validation agent for executing validation operations comprising applying the patch to the downstream software package, building the patched package and performing post-build tests;
a feedback loop for iterative patch regeneration upon validation failure, the feedback loop including a generative model to produce re-generated patches and failure data for use as input to the generative model via a prompt; and
a termination mechanism which halts the feedback loop upon successful validation or reaching a predefined iteration limit.

19. An apparatus comprising:
a processor;
a memory storing instructions that, when executed by the processor, perform a method comprising:
receiving an upstream source code and an upstream patch;
identifying a downstream software package corresponding to the upstream source code;
selecting a training shot from a store of training shots;
generating input for a generative model, the input comprising the training shot and an inference shot, the inference shot comprising the upstream source code, upstream patch, rejected hunks of the upstream patch and downstream source code;
providing the input to the generative model to generate the downstream patch.

20. A computer storage medium having computer-executable instructions that, when executed by a computing system, direct the computing system to perform operations comprising:
receiving an upstream source code and an upstream patch;
identifying a downstream software package corresponding to the upstream source code;
selecting a training shot from a store of training shots;
generating input for a generative model, the input comprising the training shot and an inference shot, the inference shot comprising the upstream source code, upstream patch, rejected hunks of the upstream patch and downstream source code;
providing the input to the generative model to generate the downstream patch; and
applying the downstream patch to the downstream software package.
